(19) United States
(12) Patent Application Publication
(10) Pub. No.: US 2004/0195906 A1
(43) Pub. Date: Oct. 7, 2004

(54) Wheel rim cover

(76) Inventor: Li Yue Huang Tsai, Tainan City (TW)

Correspondence Address: Li Yue Huang Tsai, P.O. Box 90, Tainan City, 704, TW

(21) Appl. No.: 10/405,366

(22) Filed: Apr. 3, 2003

(51) Int. Cl. B60B 7/12

(52) U.S. Cl. 301/37.33

(57) ABSTRACT

A wheel rim cover includes a cover body, a plurality of fitting blocks and a ring. Each fitting block has a press member to fit with a recessed edge of each fixing base of the cover body, with a stop member of each fitting block stopping at a projection of each fixing base, and with a hook member of each fitting block hooking in a hook hole of each fixing base. Then ring fits in all insert grooves of all the fitting blocks, forcing the hook members tightly hook with the hook holes of the fixing bases. The fitting blocks are convenient to assemble with and disassemble from the fixing bases so that cover bodies piled up take small space to reduce the cost for packaging and transporting.

### BACKGROUND OF THE INVENTION

1. Field of the Invention

This invention relates to a wheel rim cover, particularly to one provided with press members of hooking blocks pressed in recessed edges of fixing bases of a wheel rim and stop members of the hooking blocks contacting projections of the fixing base of the wheel rim, lefting hooks of the hooking blocks hooking with the hook holes of the fixing base of the wheel rim and with a ring fitted in all of insert grooves of the hooking blocks to let the ring pushing against the hooking blocks. Then the hooks of the hooking blocks tightly hook with the hook holes of the fixing base of the wheel rim, keeping the wheel rim cover stably combined with the wheel rim. The wheel rim cover is convenient to combine with or separate from the wheel rim, possible to be piled up to save space for storing away, packaging material and transportation expenditure.

2. Description of the Prior Art

A conventional wheel rim cover shown in FIGS. 1 and 2 includes a plurality of tightening bases 10, a projection 11 respectively formed in an upper and lower inner side of the tightening bases 10, a ring 12 combined with all the projections 11 spaced apart. Then the wheel rim cover can be combined with a wheel rim 1. However, the conventional wheel rim covers piled up takes large space for storing, owing to the tightening bases 11 formed integral with a wheel rim 1 and impossible to take off the wheel rim. Consequently, it needs comparatively large expenditure for storing, packaging and transporting.

### SUMMARY OF THE INVENTION

The objective of the invention is to offer a wheel rim cover possible to be piled up with a small space for packaging and transporting to save its cost.

The feature of the invention is a cover body provided with a plurality of fixing bases spaced apart equidistantly near its outer circumference, and each fixing base have a hook hole in the center portion, a recessed edge and two projections at two sides of the recessed edge in an upper side; the same number of fitting blocks as the fixing bases fit with the fixing bases, having respectively a press member in a lower portion, a hook member formed on an inner side of the press member, two stop members formed at two sides of the lower portion, and a projection respectively formed at an inner upper side and an inner lower side, and a fitting groove formed in each upper projection. The ring is fitted in all the fitting grooves of the fitting blocks.

### BRIEF DESCRIPTION OF DRAWINGS

This invention will be better understood by referring to the accompanying drawings, wherein:

FIG. 1 is a partial view of a conventional wheel rim cover combined with a wheel rim;

FIG. 2 is a side view of the conventional wheel rim covers piled up;

FIG. 3 is a partial exploded perspective view of a wheel rim cover in the present invention;

FIG. 4 is a partial view of the wheel rim cover in the present invention;

FIG. 5 is a partial cross-sectional view of the wheel rim cover in the present invention; and,

FIG. 6 is a side view of the wheel rim covers piled up in the present invention.

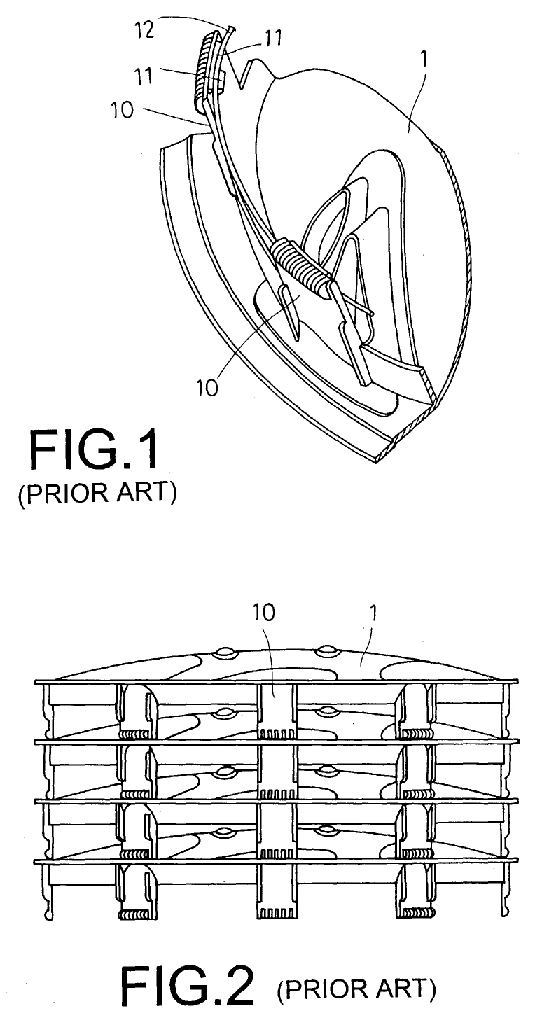

### DETAILED DESCRIPTION OF THE PREFERRED EMBODIMENT

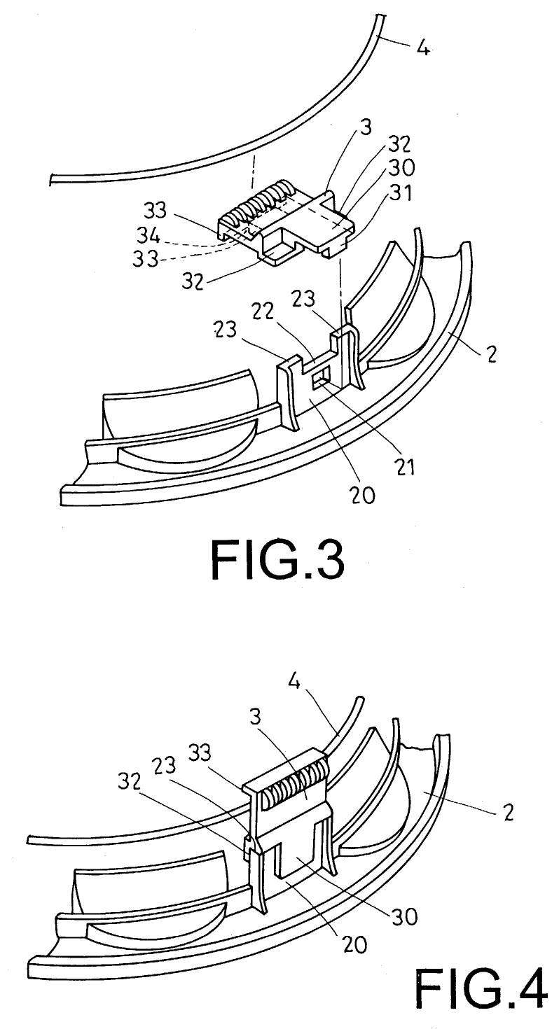

A preferred embodiment of a wheel rim cover in the present invention, as shown in FIG. 3, includes a cover body 2, a plurality of hooking blocks 3, and a ring 4 combined together.

The cover body 2 has a plurality of fixing bases 20 spaced apart equidistantly around near an outer circumference, a hook hole 21 formed in a center portion of each fixing base 20, a recessed edge 22 formed at an upper side of each fixing base 20, and a projected edge 23 formed respectively at two sides of the recessed edge 22.

Each fitting block 3 fits in each fixing base 20, having a press member 30 formed in a lower portion, a hook member 31 formed on an inner side of the press member 30, a stop member 32 respectively formed at two sides of an upper portion of the press member 30, a projection 33 respectively formed in an upper portion and an intermediate portion of the inner side. The upper projection 33 has an insert groove 34.

The ring 4 is fitted in all the insert grooves 34 of all the upper projections 33 of all the fitting blocks 3.

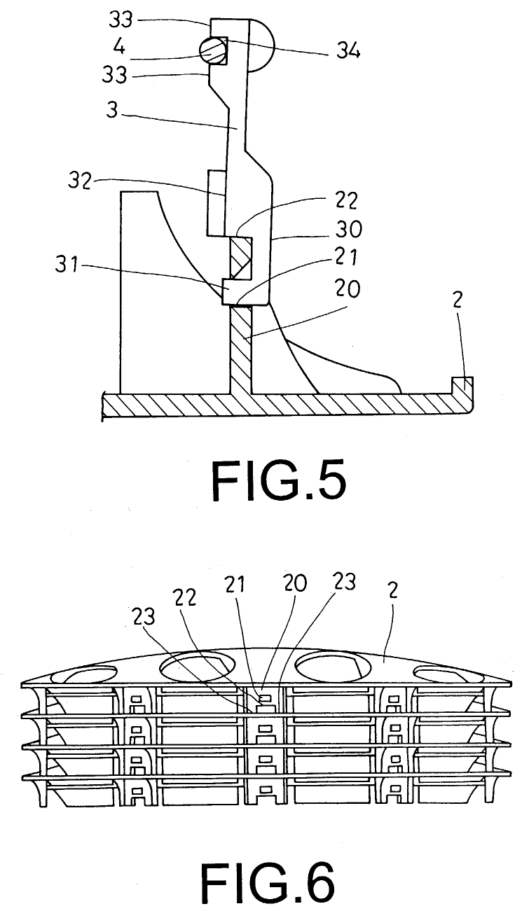

In assembling, as shown in FIGS. 3-6, the press members 30 of all the fitting blocks 3 are pressed in the recessed edges 22 of all the fixing bases 20 of the cover body 2, with the stop members 32 of the fitting blocks 3 contacting and stopped by the projected edges 23, and with the hook members 31 hooked tightly in the hook holes 21 of all the fixing bases 21. Then the ring 4 is fitted in all the insert grooves 34 of all the fitting blocks, forcing the hook members 31 more tightly hooking with the hook holes 21 of the fixing bases 2, finishing assembly of the wheel rim cover. Then the wheel rim cover can be combined with a wheel rim, with the fitting blocks 3 very convenient to assemble with and disassemble from the wheel rim. Thus the wheel rim covers may be piled up to take comparatively small space, and subsequently possible to lower cost for packaging and transporting.

The wheel rim cover in the invention has the following advantages, as can be understood from the foresaid description.

1. As the ring 4 fits in all the insert grooves 34 of the fitting blocks 3, it forces hook members 31 more tightly hook with the hook holes 21 of the fixing bases 20 of the wheel rim cover 2.

2. Each fitting block 3 hooks each hook hole 21 of each fixing base 20 of the cover body 2, very convenient to assemble and disassemble.

3. The fitting blocks 3 are convenient to take off the fixing bases so the cover body 2 takes small space after piled up one by one, possible to reduce the cost for packaging and transporting.

While the preferred embodiment of the invention has been described above, it will be recognized and understood that various modifications may be made therein and the appended claims are intended to cover all such modifications that may fall within the spirit and scope of the invention.

What is claimed is:

1. A wheel rim cover comprising:
a cover body having a plurality of fixing bases spaced apart around near its outer circumference, each said fixing base provided with a hook hole in a center portion and a recessed edge and a projecting edge at two sides of said recessed edge formed at an upper side;
the same number of fitting blocks as said fixing bases of said cover body, each said fitting block fitting in each said fitting base, each said fitting block having a press member formed in a lower portion, a hook member formed on an inner side of each said press member, a stop member respectively formed at two sides of the lower portion of each said fitting block, a projection respectively formed in an upper portion and in an intermediate portion of each said fitting block, and a fitting groove formed in the upper projection;
a ring fitted in said insert grooves of all said fitting blocks;
all said press members of all said fitting blocks fitted with said recessed edges of said fixing bases of said cover body, all said stop members of all said fitting blocks stopped at all projecting edges of all said fixing bases so that said hook members of all said fitting blocks may hook with all said hook holes of all said fixing bases, then said ring fitted in all said insert grooves of all said fitting blocks so that all hook members are forced to tightly hook in all said hook holes of all said fixing bases, said fitting blocks being very convenient to assemble with and disassemble from said fixing bases, said cover body piled up to take small space and subsequently reducing the cost for packaging and transporting.
